(19) United States
(12) Patent Application Publication
(10) Pub. No.: US 2025/0202107 A1
(43) Pub. Date: Jun. 19, 2025

(54) ANTENNA AND COMMUNICATION DEVICE

(71) Applicant: HUAWEI TECHNOLOGIES CO., LTD., Shenzhen (CN)

(72) Inventors: Meng ZOU, Shanghai (CN); Ke LONG, Shanghai (CN)

(21) Appl. No.: 19/071,959

(22) Filed: Mar. 6, 2025

Related U.S. Application Data
(63) Continuation of application No. PCT/CN2022/117393, filed on Sep. 6, 2022.

(51) Int. Cl. H01Q 3/32; H01Q 1/24; H01Q 9/04; H01Q 19/10

(52) U.S. Cl. CPC H01Q 3/32; H01Q 1/246; H01Q 9/0485; H01Q 19/10

(57) ABSTRACT

This application relates to an antenna and a communication device. An example antenna includes a reflector, a resonator, a radiator, and an enclosure frame. The resonator is disposed on a side of the reflector and is configured to filter a signal of the antenna. The radiator is disposed on a side of the resonator facing away from the reflector, and the radiator and the resonator are electrically connected. The enclosure frame is disposed on the same side on the reflector as the resonator, and forms, with the reflector, an accommodating space for accommodating the resonator and the radiator. The enclosure frame has a metal surface.

### CROSS-REFERENCE TO RELATED APPLICATIONS

This application is a continuation of International Patent Application No. PCT/CN2022/117393, filed on Sep. 6, 2022, the disclosure of which is hereby incorporated by reference in its entirety.

### TECHNICAL FIELD

This application relates to the field of antenna technologies, and in particular, to an antenna and a communication device.

### BACKGROUND

With development of modern wireless communication technologies, a communication system tends to be miniaturized, integrated, and multi-functional. Correspondingly, a communication device has an increasingly high requirement for a radio frequency link.

An antenna feeder subsystem is a key part of the radio frequency link. A gain of the antenna feeder subsystem is equal to directivity of a single-channel antenna minus an insertion loss. Therefore, the antenna needs to achieve high directivity and have a low loss feature, to achieve a high gain. In an existing antenna feeder subsystem solution, a power division network and a plurality of antenna elements are usually used to form a multi-element antenna array. In this way, although high directivity can be achieved, introduction of the power division network brings an extra insertion loss to the antenna feeder subsystem. As a result, an antenna gain is not effectively increased.

### SUMMARY

This application provides an antenna and a communication device, to reduce an antenna loss and increase an antenna gain when high directivity of the antenna is ensured.

According to a first aspect, this application provides an antenna. The antenna may include a reflector, a resonator, a radiator, and an enclosure frame. The resonator may be disposed on a side of the reflector and is configured to filter a signal of the antenna. The radiator may be disposed on a side that is of the resonator and that faces away from the reflector, and is electrically connected to the resonator. The radiator may have both an antenna radiation function and a frequency selection function of a filter. The enclosure frame may be disposed on the same side on the reflector as the resonator, and an accommodating space for accommodating the resonator and the radiator may be formed between the enclosure frame and the reflector. The enclosure frame has a metal surface. Phases of electromagnetic waves radiated or received by the radiator may be changed by using reflection performed by the metal surface on an electromagnetic wave, so that the phases of the electromagnetic waves on an aperture surface of the antenna are close to be consistent, thereby achieving high directivity of the antenna.

In the antenna provided in this application, when only one radiator is disposed, high directivity of the antenna may be achieved by using the enclosure frame. Therefore, no power division network is required, so that an insertion loss of the antenna is reduced. Because the antenna provided in this application can reduce a loss on a premise of achieving high directivity, effect of increasing a gain can be achieved.

In some possible implementation solutions, the antenna may further include a metal sheet. The metal sheet may be fastened on a side that is of the enclosure frame and that faces away from the reflector, to improve cross polarization performance of the antenna.

In some possible implementation solutions, a first extending portion and a second extending portion may be respectively disposed on two opposite sides of the metal sheet. The first extending portion and the second extending portion are respectively fastened to two opposite side walls of the enclosure frame, to fasten the metal sheet on the enclosure frame.

In some possible implementation solutions, the antenna may further include a first baffle plate and a second baffle plate. The first baffle plate and the second baffle plate are oppositely disposed on the reflector, the first baffle plate and the second baffle plate are disposed on the same side as the resonator, and the first baffle plate and the second baffle plate are separately located on an outer side of the enclosure frame. The first baffle plate and the second baffle plate each may have a metal surface, to enhance effect of adjusting an amplitude and a phase of an electromagnetic wave by the enclosure frame.

In some possible implementation solutions, the antenna may further include a phase adjustment structure. The phase adjustment structure may be disposed on the side that is of the enclosure frame and that faces away from the reflector, and may also be configured to adjust a phase of a signal of the antenna, so that signals of the antenna are close to expected phase distribution on the aperture surface of the antenna, thereby further improving directivity of the antenna.

In some possible implementation solutions, the phase adjustment structure may include a dielectric substrate and a metal pattern disposed on a surface of the dielectric substrate. A shape of the metal pattern is appropriately designed, and reflection effect of the metal pattern on an electromagnetic wave is utilized, that is, when the radiator radiates or receives an electromagnetic wave, a phase adjustment function of the electromagnetic wave may be implemented.

For example, the metal pattern may be disposed on a side that is of the dielectric substrate and that faces the reflector, or may be disposed on a side that is of the dielectric substrate and that faces away from the reflector.

In addition, in the foregoing solution, there may be one or more phase adjustment structures, and the one or more phase adjustment structures may be sequentially disposed in a direction away from the reflector. Through a transmission phase design of a metal pattern on one or more phase adjustment structures, electromagnetic waves on the aperture surface of the antenna may be adjusted to equal phases, to achieve high directivity of the antenna.

In some other possible implementation solutions, the phase adjustment structure may alternatively be made of an all-dielectric material. In this case, the phase adjustment structure may include a plurality of regions having different thicknesses in a direction perpendicular to the reflector, to implement an adjustment function on a phase of an electromagnetic wave radiated or received by the radiator.

In the foregoing solution, a thickness of the phase adjustment structure in the direction perpendicular to the reflector gradually decreases in a direction from a center of the phase adjustment structure to an edge of the phase adjustment structure. The phase adjustment structure with such thickness distribution can better adjust a phase of an electromagnetic wave. This helps further improve directivity of the antenna.

In some possible implementation solutions, the radiator may be a dielectric resonator. In this case, the radiator may be formed by a microwave dielectric material with a high dielectric constant.

In the foregoing solution, a surface on a side that is of the radiator and that faces away from the resonator may have a metal plating layer, and the metal plating layer may partially or completely cover the surface on the side of the radiator, to adjust a resonance frequency of the radiator. In addition, a surface on a side that is of the radiator and that faces the resonator may also have a metal plating layer. In this way, the metal plating layer on the surface of the radiator and a metal plating layer on a surface of the resonator may be sintered together, to relatively fasten the radiator and the resonator.

In some other possible implementation solutions, the radiator may alternatively be a microstrip resonator. During specific implementation, the microstrip resonator may be fastened on the resonator through welding.

In some possible implementation solutions, the resonator may be a dielectric resonator. In this case, the resonator may be made of a microwave dielectric material with a high dielectric constant. The resonator may include one or more resonance cavities. Each resonance cavity may provide a first-order filter suppression capability for the antenna.

In some other possible implementation solutions, the resonator may alternatively be a metal cavity resonator. In this case, the resonator may include a metal housing and a metal resonance rod disposed in the metal housing. By using the resonator in this form, an interval between a primary mode resonance frequency and a higher-order mode resonance frequency of the antenna can be expanded, thereby improving high-end suppression performance of the resonator.

In some possible implementation solutions, there may be one or more resonators, and the one or more resonators may be stacked in the direction away from the reflector. This helps to provide a filtering capability of more orders for an antenna, thereby improving radiation performance of the antenna.

In some possible implementation solutions, the radiator and the resonator may be electrically connected through a probe. Alternatively, the radiator and the resonator may be coupled through a gap. In this case, a first gap may be provided on a surface that is of the radiator and that faces the resonator, and a second gap may be provided on a surface that is of the resonator and that faces the radiator. The first gap is opposite to the second gap. Energy coupling is performed between the radiator and the resonator by using the first gap and the second gap.

According to a second aspect, this application further provides an antenna. The antenna may include a reflector, a resonator, a radiator, and a phase adjustment structure. The resonator may be disposed on a side of the reflector and is configured to filter a signal of the antenna. The radiator may be disposed on a side that is of the resonator and that faces away from the reflector, and is electrically connected to the resonator. The radiator may have both an antenna radiation function and a frequency selection function of a filter. The phase adjustment structure is disposed on a side that is of the radiator and that faces away from the reflector. The phase adjustment structure may be configured to adjust a phase of a signal of the antenna, so that signals of the antenna are close to expected phase distribution on an aperture surface of the antenna, thereby improving directivity of the antenna.

In the antenna provided in this application, when only one radiator is disposed, high directivity of the antenna may be achieved by using the phase adjustment structure. Therefore, no power division network is required, so that an insertion loss of the antenna is reduced. Because the antenna provided in this application can reduce a loss on a premise of achieving high directivity, effect of increasing a gain can be achieved.

In some possible implementation solutions, the phase adjustment structure may include a dielectric substrate and a metal pattern disposed on a surface of the dielectric substrate. A shape of the metal pattern is appropriately designed, and reflection effect of the metal pattern on an electromagnetic wave is utilized, that is, when the radiator radiates or receives an electromagnetic wave, a phase adjustment function of the electromagnetic wave may be implemented.

For example, the metal pattern may be disposed on a side that is of the dielectric substrate and that faces the reflector, or may be disposed on a side that is of the dielectric substrate and that faces away from the reflector.

In addition, in the foregoing solution, there may be one or more phase adjustment structures, and the one or more phase adjustment structures may be sequentially disposed in a direction away from the reflector. Through a transmission phase design of a metal pattern on one or more phase adjustment structures, electromagnetic waves on the aperture surface of the antenna may be adjusted to equal phases, to achieve high directivity of the antenna.

In some other possible implementation solutions, the phase adjustment structure may alternatively be made of an all-dielectric material. In this case, the phase adjustment structure may include a plurality of regions having different thicknesses in a direction perpendicular to the reflector, to implement an adjustment function on a phase of an electromagnetic wave radiated or received by the radiator.

In the foregoing solution, a thickness of the phase adjustment structure in the direction perpendicular to the reflector gradually decreases in a direction from a center of the phase adjustment structure to an edge of the phase adjustment structure. The phase adjustment structure with such thickness distribution can better adjust a phase of an electromagnetic wave. This helps further improve directivity of the antenna.

In some possible implementation solutions, the antenna may further include an enclosure frame. The enclosure frame may be disposed between the reflector and the phase adjustment structure, and an accommodating space for accommodating the resonator and the radiator may be formed between the enclosure frame and the reflector. The enclosure frame has a metal surface. Phases of electromagnetic waves radiated or received by the radiator may be changed by using reflection performed by the metal surface on an electromagnetic wave, so that the phases of the electromagnetic waves on the aperture surface of the antenna are close to be consistent, thereby further improving high directivity of the antenna.

In some possible implementation solutions, the antenna may further include a metal sheet. The metal sheet may be fastened on a side that is of the enclosure frame and that faces away from the reflector, to improve cross polarization performance of the antenna.

In some possible implementation solutions, a first extending portion and a second extending portion may be respectively disposed on two opposite sides of the metal sheet. The first extending portion and the second extending portion are respectively fastened to two opposite side walls of the enclosure frame, to fasten the metal sheet on the enclosure frame.

In some possible implementation solutions, the antenna may further include a first baffle plate and a second baffle plate. The first baffle plate and the second baffle plate are oppositely disposed on the reflector, the first baffle plate and the second baffle plate are disposed on the same side as the resonator, and the first baffle plate and the second baffle plate are separately located on an outer side of the enclosure frame. The first baffle plate and the second baffle plate each may have a metal surface, to enhance effect of adjusting an amplitude and a phase of an electromagnetic wave by the enclosure frame.

In some possible implementation solutions, the radiator may be a dielectric resonator. In this case, the radiator may be formed by a microwave dielectric material with a high dielectric constant.

In the foregoing solution, a surface on a side that is of the radiator and that faces away from the resonator may have a metal plating layer, and the metal plating layer may partially or completely cover the surface on the side of the radiator, to adjust a resonance frequency of the radiator. In addition, a surface on a side that is of the radiator and that faces the resonator may also have a metal plating layer. In this way, the metal plating layer on the surface of the radiator and a metal plating layer on a surface of the resonator may be sintered together, to relatively fasten the radiator and the resonator.

In some other possible implementation solutions, the radiator may alternatively be a microstrip resonator. During specific implementation, the microstrip resonator may be fastened on the resonator through welding.

In some possible implementation solutions, the resonator may be a dielectric resonator. In this case, the resonator may be made of a microwave dielectric material with a high dielectric constant. The resonator may include one or more resonance cavities. Each resonance cavity may provide a first-order filter suppression capability for the antenna.

In some other possible implementation solutions, the resonator may alternatively be a metal cavity resonator. In this case, the resonator may include a metal housing and a metal resonance rod disposed in the metal housing. By using the resonator in this form, an interval between a primary mode resonance frequency and a higher-order mode resonance frequency of the antenna can be expanded, thereby improving high-end suppression performance of the resonator.

In some possible implementation solutions, there may be one or more resonators, and the one or more resonators may be stacked in the direction away from the reflector. This helps to provide a filtering capability of more orders for an antenna, thereby improving radiation performance of the antenna.

In some possible implementation solutions, the radiator and the resonator may be electrically connected through a probe. Alternatively, the radiator and the resonator may be coupled through a gap. In this case, a first gap may be provided on a surface that is of the radiator and that faces the resonator, and a second gap may be provided on a surface that is of the resonator and that faces the radiator. The first gap is opposite to the second gap. Energy coupling is performed between the radiator and the resonator by using the first gap and the second gap.

According to a third aspect, this application further provides a communication device. The communication device may include a baseband processing unit and the antenna in any one of the possible implementation solutions of the first aspect and the second aspect. The antenna is electrically connected to the baseband processing unit. Because a gain of the antenna is increased, the communication device can implement better communication performance.

### BRIEF DESCRIPTION OF DRAWINGS

FIG. 1 is a diagram of a system architecture to which a communication device is applicable according to an embodiment of this application;

FIG. 2 is a diagram of a structure of a base station;

FIG. 3 is a diagram of composition of an antenna system according to a possible embodiment of this application;

FIG. 4 is a diagram of a structure of an antenna according to an embodiment of this application;

FIG. 5 is a diagram of a structure of another antenna according to an embodiment of this application;

FIG. 6a is a curve graph of filtering performance of the antenna shown in FIG. 5;

FIG. 6b is a curve graph of radiation performance of the antenna shown in FIG. 5;

FIG. 7 is a diagram of a structure of another antenna according to an embodiment of this application;

FIG. 8 is a diagram of a structure of another phase adjustment structure according to an embodiment of this application;

FIG. 9 is a diagram of a structure of another antenna according to an embodiment of this application;

FIG. 10 is a diagram of a structure of another antenna according to an embodiment of this application;

FIG. 11 is a diagram of a structure of another antenna according to an embodiment of this application;

FIG. 12 is a diagram of a structure of another antenna according to an embodiment of this application;

FIG. 13 is a diagram of a structure of another antenna according to an embodiment of this application; and

FIG. 14 is a diagram of a structure of another antenna according to an embodiment of this application.

### REFERENCE NUMERALS

1: active antenna unit; 11: radio frequency processing unit; 12: antenna; 121: resonator; 122: radiator; 123: enclosure frame;
1231: metal sheet; 1232: first extending portion; 1233: second extending portion; 124: phase adjustment structure;
1241: dielectric substrate; 1242: metal pattern; 125: baffle plate; 1251: first baffle plate; 1252: second baffle plate;
13: reflector; 14: filter;
2: pole; 3: antenna adjustment bracket; 4: radome; 5: baseband processing unit; 6: cable.

### DESCRIPTION OF EMBODIMENTS

To make the objectives, technical solutions, and advantages of this application clearer, the following further describes this application in detail with reference to the accompanying drawings. However, example implementations can be implemented in a plurality of forms, and should not be construed as being limited to the implementations described herein. Identical reference numerals in the accompanying drawings denote identical or similar structures. Therefore, repeated description thereof is omitted. Expressions of positions and directions in embodiments of this application are described by using the accompanying drawings as an example. However, changes may be also made as required, and all the changes fall within the protection scope of this application. The accompanying drawings in embodiments of this application are merely used to illustrate a relative position relationship and do not represent an actual scale.

It should be noted that specific details are set forth in the following descriptions for ease of understanding this application. However, this application can be implemented in a plurality of manners different from those described herein, and a person skilled in the art can perform similar promotion without departing from the connotation of this application. Therefore, this application is not limited to the following disclosed specific implementations.

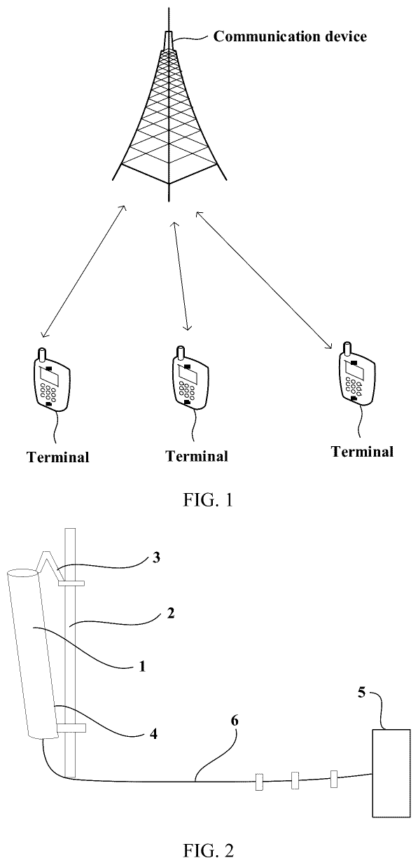

FIG. 1 is a diagram of an example of a system architecture to which an embodiment of this application is applicable. As shown in FIG. 1, the system architecture includes a communication device and a terminal in a radio access network, and wireless communication may be performed between the communication device and the terminal. The embodiment shown in FIG. 1 is described by using an example in which the communication device is a base station. The base station may be located in a base station subsystem (BBS), a terrestrial radio access network (UTRAN), or an evolved terrestrial radio access network (E-UTRAN), and is configured to perform cell coverage of a radio signal, to implement a connection between a terminal device and a wireless network radio frequency end. Specifically, the base station may be a base transceiver station (BTS) in a GSM or CDMA system, may be a NodeB (NB) in a WCDMA system, may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a gNodeB in a 5G network, a base station in a future evolved public land mobile network (PLMN), or the like, for example, a new radio base station. This is not limited in this embodiment of this application.

FIG. 2 is a diagram of a structure of the base station according to an embodiment of this application. The base station includes structures such as an active antenna unit (AAU) 1, a pole 2, and an antenna adjustment bracket 3. The active antenna unit 1 may be disposed in a radome 4. The radome 4 has a good electromagnetic wave penetration feature in terms of electrical performance, and can withstand impact of an external harsh environment in terms of mechanical performance, thereby protecting the AAU from impact of the external environment. The radome 4 may be mounted on the pole 2 or a tower by using the antenna adjustment bracket 3, to facilitate signal receiving or transmitting of the AAU. In addition, the communication device may further include a baseband processing unit 5, and the baseband processing unit 5 is located at a remote end of the AAU. The AAU may be connected to the baseband processing unit 5 through a cable 6.

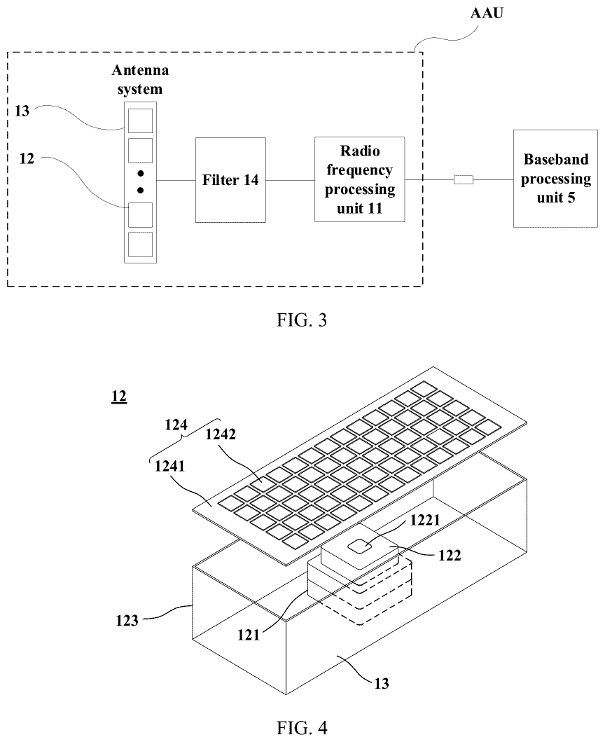

More specifically, refer to FIG. 2 and FIG. 3 together. FIG. 3 is a diagram of composition of the AAU according to a possible embodiment of this application. The AAU 1 may usually include a radio frequency processing unit 11 and an antenna system. The antenna system may include one or more antennas 12. The radio frequency processing unit 11 is connected to a feeding structure of each antenna 12. For example, the radio frequency processing unit 11 may be configured to: perform frequency selection, amplification, and conversion processing on a signal received by the antenna 12, convert a processed signal into an intermediate frequency signal or a baseband signal, and send the intermediate frequency signal or the baseband signal to the baseband processing unit 5. Alternatively, the radio frequency processing unit 11 is configured to: perform up-conversion and amplification processing on an intermediate frequency signal of the baseband processing unit 5, and convert a processed signal into an electromagnetic wave and send the electromagnetic wave by using the antenna 12. The baseband processing unit 5 is connected to the radio frequency processing unit 11, and is configured to process the intermediate frequency signal or the baseband signal sent by the radio frequency processing unit 11.

The antenna system may further include a reflector, and the one or more antennas are separately disposed on the reflector 13. In the antenna system, frequencies of different antennas 12 may be the same or different. The reflector 13 may also be referred to as a floor, an antenna panel, a reflection surface, or the like. When the antenna 12 receives a signal, the reflector 13 may reflect and aggregate the signal of the antenna 12 on a receiving point. When the antenna 12 transmits a signal, the signal may be transmitted to the reflector 13 and reflected and transmitted by the reflector 13. The antenna 12 is usually placed on a surface on a side of the reflector 13. This can greatly enhance a signal receiving or transmitting capability of the antenna, and can also block and shield interference caused to antenna signal receiving by another electromagnetic wave from a rear surface of the reflector 13 (in this application, the rear surface of the reflector 13 is a surface on a side facing away from the surface that is of the reflector 13 and that is used for disposing the antenna 12).

In some implementations, the AAU may further include a filter 14. The filter 14 is connected between the antenna and the radio frequency processing unit, and is configured to filter a signal transmitted or received by the antenna 12, to suppress electromagnetic energy in a non-operating frequency band, and improve radiation performance of the antenna 12.

For a multi-channel large-scale antenna system including a plurality of antennas, an aperture area allocated to each channel of the antenna system is determined by a quantity of channels and a module size. To achieve maximum coverage, an antenna corresponding to each channel is required to achieve maximum gain performance under a given aperture surface. A gain of an antenna is equal to directivity (dB) of a single-channel antenna minus an insertion loss (dB). Therefore, the antenna system needs to achieve high directivity and have a low loss feature, to achieve a high gain. However, in the existing solution, a multi-element feature of an antenna is usually implemented in a form of a power division network and a plurality of radiators. In this way, although directivity of the antenna can be improved, because introduction of the power division network brings a specific insertion loss to the antenna, a gain of the antenna is not effectively increased. In addition, because the antenna and the filter are designed independently, the antenna and the filter need to be cascaded together through a transmission line or a matching circuit to perform impedance matching. However, the additional transmission line or matching circuit increases a size of the entire antenna system, and also causes an additional insertion loss to the antenna. Consequently, an increase in the gain of the antenna is further limited.

For the foregoing problem, an embodiment of this application provides an antenna, to reduce an insertion loss of the antenna on a premise of achieving high directivity of the antenna, thereby effectively increasing a gain of the antenna. The following further describes this application in detail with reference to the accompanying drawings and specific embodiments.

FIG. 4 is a diagram of a structure of an antenna 12 according to an embodiment of this application. As shown in FIG. 4, the antenna 12 may include a reflector 13, a resonator 121, a radiator 122, an enclosure frame 123, and a phase adjustment structure 124. The resonator 121 is disposed on a surface on a side of the reflector 13. The radiator 122 is disposed on a side that is of the resonator 121 and that faces away from the reflector 13, and the radiator 122 and the resonator 121 are electrically connected. The enclosure frame 123 may be disposed on the side that is of the reflector 13 and on which the resonator 121 and the radiator 122 are disposed, and is connected to the reflector 13, to form an accommodating space to accommodate the resonator 121 and the radiator 122. The phase adjustment structure 124 is disposed on a side that is of the enclosure frame 123 and that faces away from the reflector 13, and a projection of the phase adjustment structure 124 onto the surface of the reflector 13 may partially or completely cover a projection of the radiator 122 onto the surface of the reflector 13.

In this embodiment, in addition to being configured to reflect an electromagnetic wave, the reflector 13 may also support and fasten an overall structure of the antenna 12. For example, the reflector 13 may be a metal plate, or may be a printed circuit board (PCB). This is not limited in this application. In addition, a shape of a cross section of the reflector 13 perpendicular to a thickness direction of the reflector 13 is not limited to a rectangle shown in FIG. 4. In some other implementations, the cross section of the reflector 13 may alternatively be a circle, an ellipse, or another regular or irregular shape. This is not limited in this application.

The resonator 121 may be used as a component of the filter 14 shown in FIG. 3, to filter a radio frequency signal transmitted or received by the antenna 12, to suppress electromagnetic energy in a non-operating frequency band. There may be one or more resonators 121. This is not limited in this application. For example, FIG. 4 shows a case in which there are two resonators 121. In this case, the two resonators 121 may be stacked in a direction away from the reflector 13. In addition, each resonator 121 may include one or more resonance cavities. Each resonance cavity may provide a first-order filter suppression capability for the antenna 12, that is, filter the electromagnetic energy in the non-operating frequency band of the antenna 12 once. In a plurality of resonators 121, quantities of resonance cavities of the resonators 121 may be equal or may be unequal. This is also not limited in this application. During actual application, a quantity of resonators 121 and a quantity of resonance cavities in the resonator 121 may be appropriately designed based on a frequency band of a signal of the antenna 12, to filter out an electromagnetic wave outside the frequency band.

In a possible embodiment, the resonator 121 may be a dielectric resonator. In this case, the resonator 121 may be formed by a ceramic dielectric block. For example, a main component of the ceramic dielectric block of the resonator 121 includes but is not limited to high dielectric constant ceramics such as barium titanate (BaTiO₃), barium carbonate (BaCO₃), BaO-Ln₂O₃-TiO₃-2-based microwave dielectric ceramics, or composite perovskite-based microwave dielectric ceramics. It should be noted that, in this embodiment of this application, a high dielectric constant may be understood as a relatively high dielectric constant that may be applied to a dielectric filter. For example, the dielectric constant may be greater than 6. However, this application does not exclude a case in which the dielectric constant is less than or equal to 6, provided that a filtering requirement is met.

In addition, all surfaces of the resonator 121 may have metal plating layers. The metal plating layer may reduce a risk of energy radiation or leakage in the resonance cavity, thereby helping improve performance of the resonator 121. For example, a material of the metal plating layer on the surface of the resonator 121 includes but is not limited to silver, gold, tin, or the like. When there are a plurality of resonators 121, metal plating layers on surfaces of adjacent resonators 121 may be sintered together, to fasten the resonators 121.

As a main body of an antenna radiation function, in addition to being configured to radiate or receive an electromagnetic wave, the radiator 122 may also have a resonance property, and can collect and store electromagnetic energy. Therefore, the radiator 122 may also be used as a component of a filter of the antenna 12 to provide a specific frequency selection capability. In other words, the radiator 122 in this embodiment of this application has both an antenna radiation function and a frequency selection function of the filter. The filter and the radiator 122 are integrated and fused, so that an overall structure of the antenna 12 is compact, thereby helping reduce a size of the antenna 12. An electrical connection between the radiator 122 and the resonator 121 may be a direct electrical connection (for example, through a probe or a transmission line) or a coupling connection. This is not specifically limited in this application. When the radiator 122 is coupled and connected to the resonator 121, because a transmission line or a matching circuit may be omitted, the size of the antenna 12 can be reduced, and an insertion loss of the antenna 12 can also be reduced. The coupling connection may be understood as a connection manner in which there is no direct electrical contact between the radiator 122 and the resonator 121, but signal energy can be transmitted between the radiator 122 and the resonator 121 through interaction, to implement signal transfer.

In this embodiment of this application, the radiator 122 is simultaneously used by two channels, and each channel corresponds to one signal. Based on this, the antenna 12 provided in this embodiment of this application may be used as a dual-polarized antenna. Polarization directions of two signals corresponding to the antenna 12 may be orthogonal, for example, may be +45 degrees and −45 degrees respectively. In this case, the radiator 122 may respectively radiate electromagnetic energy of the two channels to a space with polarized electromagnetic waves at +45 degrees and −45 degrees. In addition, with reference to an out-of-band suppression function of the radiator, the radiator may provide a first-order filter suppression capability for each channel.

In a possible implementation, the radiator 122 may be in a form of a dielectric resonator antenna. In this case, the radiator 122 may be specifically a dielectric resonator formed by a microwave dielectric material with a high dielectric constant. For example, a main component of the radiator 122 includes but is not limited to high dielectric constant ceramics such as barium titanate (BaTiO₃), barium carbonate (BaCO₃), BaO-Ln₂O₃-TiO₃-2-based microwave dielectric ceramics, or composite perovskite-based microwave dielectric ceramics.

When the radiator 122 is disposed on the resonator 121, a metal plating layer may be disposed on a surface that is of the radiator 122 and that faces the resonator 121. In this way, the metal plating layer on the surface of the radiator 122 and a metal plating layer on a surface of the resonator 121 may be sintered together, to relatively fasten the radiator 122 and the resonator 121. In addition, a surface that is of the radiator 122 and that faces away from the resonator 121 may also have a metal plating layer, and the metal plating layer may partially or completely cover the surface on a side of the radiator 122, to adjust a resonance frequency of the radiator 122. For example, a material of the metal plating layer on the surface of the radiator 122 includes but is not limited to silver, gold, tin, or the like. In some other embodiments, no metal plating layer may be disposed on a surface that is of the radiator 122 and that faces away from the resonator 121. This is not limited in this application.

In another possible implementation, the radiator 122 may alternatively be implemented by a microstrip resonator. The microstrip resonator also has both the frequency selection function of the filter and the radiation performance of the antenna. During specific implementation, the microstrip resonator may be fastened on the resonator 121 through welding.

In some embodiments, the radiator 122 and the resonator 121 may be electrically connected through a probe. During specific implementation, the probe (not shown in the figure) may be disposed on the surface that is of the radiator 122 and that faces the resonator 121, and a metallized through hole (not shown in the figure) may be provided at a position that corresponds to the probe and that is on a surface that is of the resonator 121 and that faces the radiator 121. Signal energy is transmitted between the radiator 122 and the resonator 121 through the probe and the metallized through hole. Alternatively, the probe may be disposed on a surface that is of the resonator 121 and that faces the radiator 122, and correspondingly, a metalized through hole is provided at a position that corresponds to the probe and that is on the surface that is of the radiator 122 and that faces the resonator 121. In this way, signal transmission between the radiator 122 and the resonator 121 can also be implemented.

In some other embodiments, the radiator 122 and the resonator 121 may alternatively be coupled and connected through a gap. During specific implementation, a first gap (not shown in the figure) may be provided on the surface that is of the radiator 122 and that faces the resonator 121, and a second gap (not shown in the figure) may be provided on a surface that is of the resonator 121 and that faces the radiator 122. The first gap may extend in a direction away from the resonator 121, the second gap may extend in a direction away from the radiator 122, and the first gap is opposite to the second gap. Energy coupling is performed between the radiator 122 and the resonator 121 by using the first gap and the second gap. Specific forms of the first gap and the second gap may be circular holes, square holes, or hole-shaped structures of another shapes. This is not limited in this application.

Still refer to FIG. 4. The enclosure frame 123 is a frame-shaped structure that is circumferentially closed and has openings on upper and lower sides. The enclosure frame may have a metal surface, and a function of the metal surface is to change, by using reflection performed by a metal conductor on an electromagnetic wave, phases of electromagnetic waves radiated or received by the radiator 122, so that the phases of the electromagnetic waves on an aperture surface of the antenna 12 are close to be consistent, to fully utilize a size of the aperture surface and achieve high directivity of the antenna 12. Based on the foregoing function of the enclosure frame, in this embodiment of this application, high directivity of the antenna does not need to be achieved in a design form of a plurality of radiators. In other words, in this embodiment of this application, when only one radiator is disposed, high directivity of the antenna may be achieved by using the enclosure frame. Therefore, no power division network is required. Therefore, an insertion loss of the antenna 12 is also reduced. In combination with the insertion loss reduced in the foregoing coupling connection manner of the radiator 122 and the resonator 121, an overall insertion loss of the antenna 12 may be significantly reduced. That is, the antenna 12 may reduce a loss on a premise of achieving high directivity, thereby increasing a gain.

In some implementations, the enclosure frame 123 may be of an all-metal structure. For example, a material of the enclosure frame may be specifically a metal such as copper or aluminum. In some other implementations, the enclosure frame 123 may alternatively be made of a plastic material. In this case, a metal surface may be obtained by performing metallization processing such as coating or electroplating on a surface of the enclosure frame 123. It should be noted that, a shape of the enclosure frame 123 is not limited to a rectangular frame shown in FIG. 4. In some other implementations, the enclosure frame 123 may alternatively be a circular frame, a polygonal frame, or the like, provided that the resonator 121 and the radiator 122 can be enclosed in the enclosure frame 123. This is not limited in this application.

Still refer to FIG. 4. In this embodiment, the phase adjustment structure 124 has a function similar to that of the enclosure frame 123, and may be configured to adjust a phase of an electromagnetic wave transmitted or received by the antenna 12, so that electromagnetic waves are close to expected phase distribution on the aperture surface of the antenna 12, thereby helping achieve high directivity of the antenna 12.

In a specific embodiment, the phase adjustment structure 124 may be approximately a plate structure. When the phase adjustment structure 124 is fastened, the antenna 12 may further include a support column (not shown in the figure). One end of the support column is fastened to the reflector 13, and the other end is fastened to the phase adjustment structure 124, so that the phase adjustment structure 124 is supported above the enclosure frame 123, to relatively fasten the phase adjustment structure 124 and the reflector 13. There may be one or more support columns. This is not limited in this application. When there are a plurality of support columns, the plurality of support columns may be evenly arranged along an edge of the phase adjustment structure 124, to improve support stability of the phase adjustment structure 124. Certainly, in some other implementations, the phase adjustment structure 124 may alternatively be directly fastened on a top of the enclosure frame 123, to help simplify the overall structure of the antenna 12.

In addition, a shape of a cross section of the phase adjustment structure 124 in a direction perpendicular to the reflector 13 is not limited to a rectangle in FIG. 4. In some other implementations, a shape of a cross section of the phase adjustment structure 124 may alternatively be a circle, an ellipse, or another regular or irregular shape. This is not limited in this application.

In some embodiments, the phase adjustment structure 124 may include a dielectric substrate 1241 and a metal pattern 1242 disposed on a surface of the dielectric substrate 1241. In this case, the phase adjustment structure 124 may be manufactured by using a printed circuit board (printed circuit board, PCB) manufacturing process. The metal pattern 1242 may be disposed on a side that is of the dielectric substrate 1241 and that faces the radiator 122, or may be disposed on a side that is of the dielectric substrate 1241 and that faces away from the radiator 122. A shape of the metal pattern 1242 on the surface of the dielectric substrate 1241 is appropriately designed, and reflection effect of the metal pattern 1242 on an electromagnetic wave is utilized, that is, when the radiator 122 radiates or receives an electromagnetic wave, a phase of the electromagnetic wave may be adjusted, so that the phase of the electromagnetic wave is close to an expected phase on the aperture surface of the antenna. For example, as shown in FIG. 4, the metal pattern 1242 may be a plurality of rectangular metal patches arranged in an array.

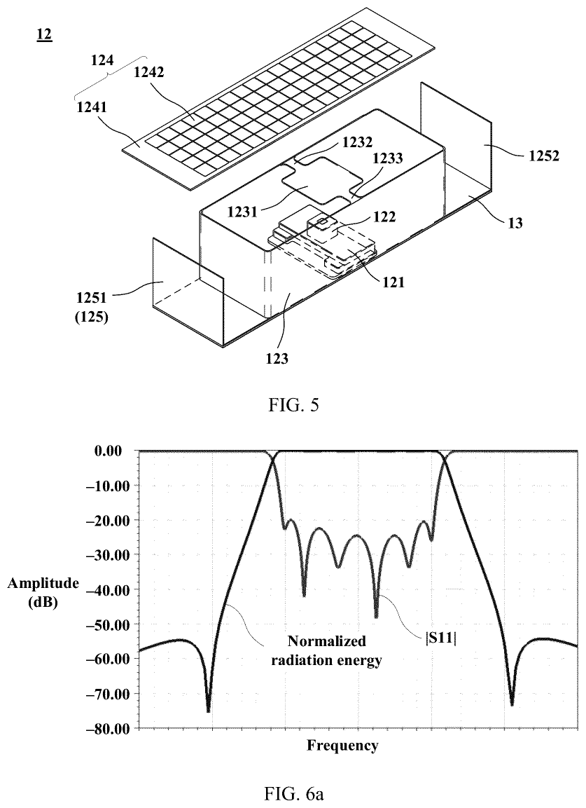

FIG. 5 is a diagram of a structure of another antenna 12 according to an embodiment of this application. As shown in FIG. 5, in this embodiment, the antenna may further include a baffle plate 125. The baffle plate 125 may be disposed on an outer side of an enclosure frame 123. The baffle plate 125 also has a metal surface, to enhance effect of adjusting an amplitude and a phase of an electromagnetic wave by the enclosure frame 123, thereby helping further improve directivity of the antenna 12. In an implementation, there may be two baffle plates 125, namely, a first baffle plate 1251 and a second baffle plate 1252 shown in FIG. 5. The first baffle plate 1251 and the second baffle plate 1252 may be oppositely disposed on a reflector 13. As shown in FIG. 5, the first baffle plate 1251 and the second baffle plate 1252 are respectively disposed on two sides of the enclosure frame 123.

Similar to the enclosure frame 123, when metal surface features of the first baffle plate 1251 and the second baffle plate 1252 are implemented, the first baffle plate 1251 and the second baffle plate 1252 may use an all-metal material, or may use another non-metal material and metal surfaces are obtained through metallization processing. This is not limited in this application.

In some possible embodiments, a metal sheet 1231 may be further disposed on a side that is of the enclosure frame 123 and that faces away from the reflector 13. The metal sheet 1231 may partially cover a top of the enclosure frame 123, to improve cross polarization performance of the antenna 12. In an implementation, the metal sheet 1231 may be approximately rectangular, and a first extending portion 1232 and a second extending portion 1233 may be respectively disposed on two opposite sides of the metal sheet 1231. When the enclosure frame 123 is a rectangular frame, the first extending portion 1232 and the second extending portion 1233 may be respectively fastened to two opposite side walls of the enclosure frame 123, to relatively fasten the metal sheet 1231 and the enclosure frame 123. For example, a manner of fastening the first extending portion 1232 and the second extending portion 1233 to the enclosure frame 123 includes but is not limited to welding.

In this embodiment, a resonator 121 may be a dielectric resonator of a single-layer structure. The resonator 121 may include eight resonance cavities, and energy coupling and a connection may be performed between the resonance cavities by using a medium window. Two polarization channels of the antenna 12 are defined as a first channel and a second channel respectively. In a specific design, four resonance cavities may be used by the first channel of the antenna 12 and provide a fourth-order filter suppression capability for the first channel, and the other four resonance cavities may be used by the second channel of the antenna 12 and provide a fourth-order filter suppression capability for the second channel. That is, the resonators in this embodiment may perform four times of filtering on a signal of the first channel and a signal of the second channel respectively.

In addition, in this embodiment of this application, the reflector 13, the enclosure frame 123, and a phase adjustment structure 124 may also form a resonance structure. The resonance structure may implement a function similar to that of a Fabry-Pérot resonance cavity, and may simultaneously provide first-order filter suppression capabilities for the two channels of the antenna 12. In this way, with reference to first-order filter suppression capabilities respectively provided by a radiator 122 for the two channels and the fourth-order filter suppression capability provided by the resonator 121 for each channel, the antenna 12 provided in this embodiment may provide a sixth-order filter suppression capability for each channel.

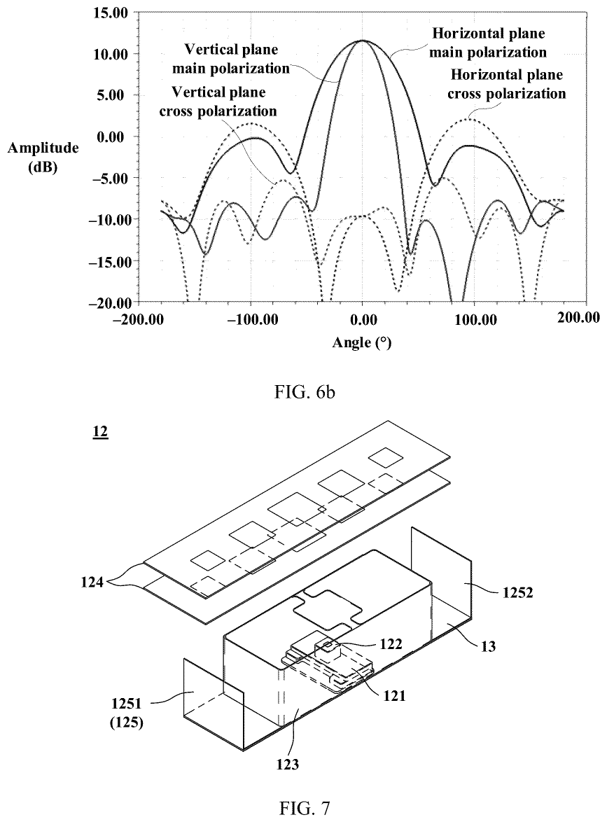

FIG. 6a is a curve graph of filtering performance of the antenna 12 shown in FIG. 5. In FIG. 6a, a horizontal coordinate is a frequency, and a vertical coordinate is an amplitude (dB). Two curves respectively represent an S11 parameter curve and a normalized radiation energy curve, where S11 is an input reflection coefficient, namely, an input return loss. A port reflection coefficient represented by the S11 parameter curve has six poles, and a suppression feature represented by the normalized radiation energy curve is consistent with a sixth-order Chebyshev curve. This indicates that in this embodiment, a frequency selection function of a sixth-order filter used by an antenna in an existing solution can be implemented by using only four resonance cavities of the resonator 121, and in comparison with the existing solution, a gain obtained after an insertion loss is reduced due to reduction of two resonance cavities can be obtained.

FIG. 6b is a curve graph of radiation performance of the antenna 12 shown in FIG. 5. In FIG. 6b, a horizontal coordinate is a radiation angle of a signal of the antenna, and a vertical coordinate is an amplitude (dB). Four curves respectively represent directions of horizontal plane main polarization, horizontal plane cross polarization, vertical plane main polarization, and vertical plane cross polarization of the antenna. It can be seen from FIG. 6b that an angle of the vertical plane main polarization is clearly narrower than an angle of the horizontal plane main polarization, that is, a beam width of the antenna in a vertical plane is narrower than a beam width of the antenna in a horizontal plane, and effect is equivalent to that of a conventional three-element array antenna solution, that is, the antenna provided in this embodiment of this application implements effect similar to that of a three-element array antenna. Because no power division network is required in this solution, a gain obtained after an insertion loss is reduced due to removal of the power division network can be obtained on a premise that directivity equivalent to that of the current three-element array antenna is achieved.

FIG. 7 is a diagram of a structure of another antenna 12 according to an embodiment of this application. As shown in FIG. 7, in this embodiment, the antenna 12 may include two phase adjustment structures 124, and the two phase adjustment structures 124 may be sequentially stacked in a direction away from a reflector 13. During specific implementation, arrangement densities of metal patterns on the two phase adjustment structures may be sparse, so that electromagnetic waves on an aperture surface of the antenna 12 are adjusted to equal phases through electromagnetic wave transmission of a region that is on dielectric substrates and that is other than the metal patterns, thereby achieving high directivity of the antenna 12. Similar to the foregoing embodiment, the antenna 12 provided in this embodiment can also implement radiation performance similar to that of a three-element array antenna.

In a specific embodiment, the upper and lower phase adjustment structures 124 may be disposed at intervals, and may be separately supported and fastened on the reflector 13 by using different support columns. In addition, shapes of the metal patterns of the two phase adjustment structures 124 may be the same or different. Specifically, the shapes of the metal patterns may be designed according to an actual requirement of the antenna 12. This is not limited in this application. In addition, in the foregoing embodiment, a case in which there are one or two phase adjustment structures 124 is described by using an example. It should be understood that in some other embodiments, there may be three or more phase adjustment structures 124. In this case, the plurality of phase adjustment structures 124 may be sequentially stacked in the direction away from a reflector 13, and an appropriate support manner is selected with reference to a case of the foregoing two phase adjustment structures 124, to support and fasten the plurality of phase adjustment structures 124. Details are not described herein again.

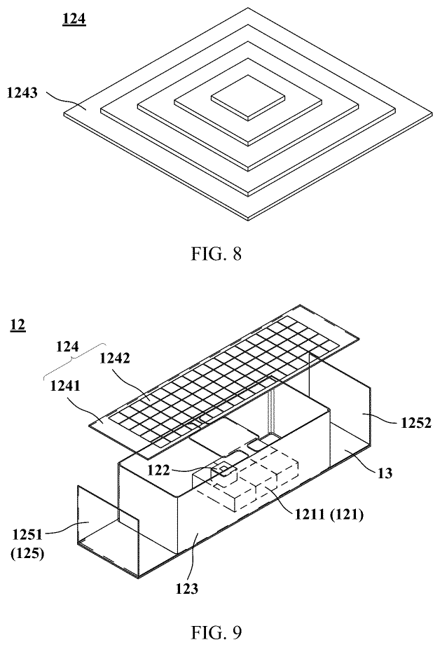

In the foregoing embodiments, in addition to a combination form of a dielectric plate and a metal pattern, the phase adjustment structure may alternatively use a design form of an all-dielectric material. FIG. 8 is a diagram of a structure of another phase adjustment structure 124 according to an embodiment of this application. As shown in FIG. 8, in this embodiment, the phase adjustment structure 124 is made of a dielectric material as a whole, and different regions of the phase adjustment structure 124 are designed to have different thicknesses, to implement phase adjustment of an electromagnetic wave radiated or received by a radiator, so that phases of electromagnetic waves on an aperture surface of the antenna are close to be consistent. It should be noted that, in this embodiment, a thickness of the phase adjustment structure 124 may be understood as a size of the phase adjustment structure 124 in a direction perpendicular to the reflector.

In a specific embodiment, the thickness of the phase adjustment structure 124 may gradually decrease in a direction from a center of the phase adjustment structure 124 to an edge of the phase adjustment structure 124. That is, the phase adjustment structure 124 may be approximately thick in a middle and thin at the edge. The phase adjustment structure 124 with such thickness distribution can better adjust a phase of an electromagnetic wave. This helps further improve directivity of the antenna.

In a possible implementation, the thickness of the phase adjustment structure 124 may gradually decrease in a step-like manner in the direction from the center of the phase adjustment structure 124 to the edge of the phase adjustment structure 124. In this case, the phase adjustment structure 124 may be considered as including a plurality of ring structures 1243. The plurality of ring structures 1243 are sequentially arranged in the direction from the center to the edge, and in the arrangement direction, thicknesses of the ring structures 1243 sequentially decrease.

In another possible implementation, the thickness of the phase adjustment structure may decrease linearly in the direction from the center of the phase adjustment structure to the edge of the phase adjustment structure. In this case, a surface on which the center of the phase adjustment structure points to the edge of the phase adjustment structure is of a downward inclined plane structure. Alternatively, in some other possible implementations, the thickness of the phase adjustment structure may gradually decrease in an arc-shape manner in the direction from the center of the phase adjustment structure to the edge of the phase adjustment structure. In this case, a surface on which the center of the phase adjustment structure points to the edge of the phase adjustment structure is of a downward inclined curved surface structure.

FIG. 9 is a diagram of a structure of another antenna 12 according to an embodiment of this application. As shown in FIG. 9, in this embodiment, a resonator 121 may be a metal cavity resonator. In this case, the resonator 121 may include a metal housing 1211 and a metal resonance rod (not shown in the figure) disposed in the metal housing 1211. By using this structure design, an interval between a primary mode resonance frequency and a higher-order mode resonance frequency of the antenna 12 can be expanded, thereby improving high-end suppression performance of the resonator 121. There may be a plurality of resonators 121. The plurality of resonators 121 may be disposed at a same layer on a reflector. Alternatively, the plurality of resonators 121 may be distributed at a plurality of layers, and each layer may include one or more resonators 121 disposed in an array. Each resonator 121 may provide a first-order filter suppression capability for the antenna 12.

In addition, in this embodiment, components such as a radiator 122, an enclosure frame 123, a phase adjustment structure 124, and a baffle plate 125 may be designed with reference to any one of the foregoing embodiments. Details are not described herein again. The antenna 12 provided in this embodiment can implement radiation performance similar to that of a three-element array antenna.

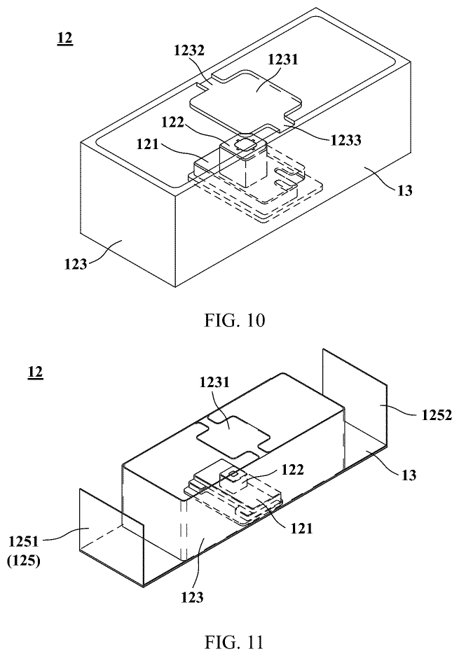

FIG. 10 is a diagram of a structure of another antenna 12 according to an embodiment of this application. As shown in FIG. 10, the antenna 12 may include a reflector 13, a resonator 121, a radiator 122, and an enclosure frame 123. The resonator 121 is disposed on a surface on a side of the reflector 13, the radiator 122 is disposed on a side that is of the resonator 121 and that faces away from the reflector 13, and the radiator 122 and the resonator 121 are electrically connected. The enclosure frame 123 may be disposed on the side that is of the reflector 13 and on which the resonator 121 and the radiator 122 are disposed, and is connected to the reflector 13, to form an accommodating space to accommodate the resonator 121 and the radiator 122.

In this embodiment, structures of the reflector 13, the resonator 121, the radiator 122, and the enclosure frame 123 may be set with reference to any one of the foregoing embodiments. Details about these components are not described herein again. A difference from the foregoing embodiment is that, a phase adjustment structure is omitted from the antenna in this embodiment of this application. Therefore, a phase adjustment function is mainly implemented by the enclosure frame 123. Phases of electromagnetic waves radiated or received by the antenna are changed by using reflection effect of a metal surface of the enclosure frame 123 on an electromagnetic wave, so that the phases of the electromagnetic waves on an aperture surface of the antenna 12 are close to be consistent, to utilize a size of the aperture surface to a maximum extent and achieve high directivity of the antenna 12. Because no power division network is required, a loss of the antenna 12 is also reduced. In combination with an insertion loss reduced in a coupling connection manner of the radiator 122 and the resonator 121, an overall loss of the antenna 12 may be significantly reduced. That is, the antenna 12 may reduce a loss on a premise of achieving high directivity, thereby increasing a gain. In addition, in this embodiment, because the phase adjustment structure is omitted, a cross-sectional height of the antenna 12 is relatively low. This facilitates mounting of the antenna 12 in a communication device.

In some possible embodiments, a metal sheet 1231 may be further disposed on a side that is of the enclosure frame 123 and that faces away from the reflector 13. The metal sheet 1231 may partially cover a top of the enclosure frame 123, to improve cross polarization performance of the antenna 12. In an implementation, the metal sheet 1231 may be approximately rectangular, and a first extending portion 1232 and a second extending portion 1233 may be respectively disposed on two opposite sides of the metal sheet 1231. When the enclosure frame 123 is a rectangular frame, the first extending portion 1232 and the second extending portion 1233 may be respectively fastened to two opposite side walls of the enclosure frame 123, to relatively fasten the metal sheet 1231 and the enclosure frame 123. For example, a manner of fastening the first extending portion 1232 and the second extending portion 1233 to the enclosure frame 123 includes but is not limited to welding.

FIG. 11 is a diagram of a structure of another antenna 12 according to an embodiment of this application. As shown in FIG. 11, in this embodiment, a first baffle plate 1251 and a second baffle plate 1252 may be disposed on an outer side of an enclosure frame 123. Both the first baffle plate 1251 and the second baffle plate 1252 have a metal surface, and the first baffle plate 1251 and the second baffle plate 1252 are oppositely disposed on a reflector 13, to enhance effect of adjusting an amplitude and a phase of an electromagnetic wave by the enclosure frame 123, thereby helping further improve directivity of the antenna 12.

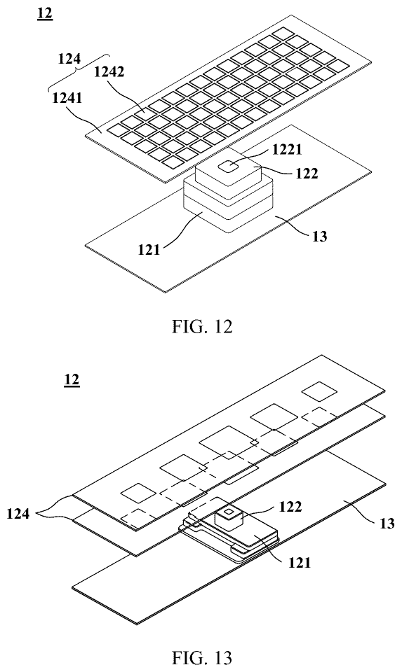

FIG. 12 is a diagram of a structure of another antenna according to an embodiment of this application. As shown in FIG. 12, the antenna 12 may include a reflector 13, a resonator 121, a radiator 122, and a phase adjustment structure 124. The resonator 121 is disposed on a surface on a side of the reflector 13, the radiator 122 is disposed on a side that is of the resonator 121 and that faces away from the reflector 13, and the radiator 122 and the resonator 121 are electrically connected. The phase adjustment structure 124 may be disposed on a side that is of the radiator 122 and that faces away from the reflector 13.

In this embodiment, structures of the reflector 13, the resonator 121, the radiator 122, and the phase adjustment structure 124 may all be set with reference to any one of the foregoing embodiments. Details about these components are not described herein again. FIG. 12 shows a specific structure obtained when the phase adjustment structure 124 uses a combination form of a dielectric substrate 1241 and a metal pattern 1242. A difference from the foregoing embodiment is that, an enclosure frame is omitted from the antenna 12 in this embodiment of this application. Therefore, a phase adjustment function is mainly implemented by the phase adjustment structure 124. The phase adjustment structure 124 adjusts phases of electromagnetic waves on an aperture surface of the antenna 12 to be approximately equal, to utilize a size of the aperture surface to a maximum extent and achieve high directivity of the antenna. Because no power division network is required, a loss of the antenna 12 is also reduced. In combination with an insertion loss reduced in a coupling connection manner of the radiator 122 and the resonator 121, an overall loss of the antenna 12 may be significantly reduced. That is, the antenna 12 may reduce a loss on a premise of achieving high directivity, thereby increasing a gain. In addition, in this embodiment, because the enclosure frame is omitted, an overall weight of the antenna 12 is reduced.

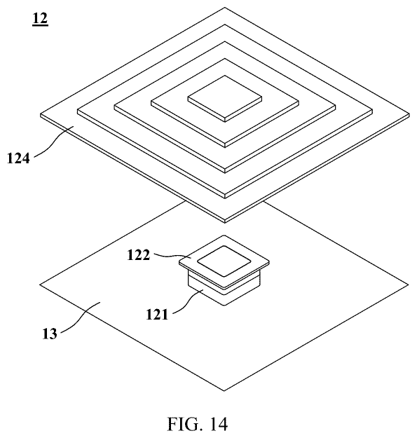

FIG. 13 is a diagram of a structure of another antenna 12 according to an embodiment of this application. As shown in FIG. 13, an enclosure frame is also omitted from the antenna 12 in this embodiment. For designs of a reflector 13, a resonator 121, a radiator 122, and a phase adjustment structure 124, still refer to setting manners in any one of the foregoing embodiments. Another specific structure obtained when the phase adjustment structure 124 uses a combination form of a dielectric substrate 1241 and a metal pattern 1242 is shown herein.

FIG. 14 is a diagram of a structure of another antenna 12 according to an embodiment of this application. As shown in FIG. 14, an enclosure frame is also omitted from the antenna in this embodiment. For designs of a reflector 13, a resonator 121, a radiator 122, and a phase adjustment structure 124, still refer to setting manners in any one of the foregoing embodiments. A specific structure obtained when the phase adjustment structure is made of an all-dielectric material is shown herein. The antenna 12 provided in this embodiment can implement radiation performance similar to that of a quad-element array antenna.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna, comprising a reflector, a resonator, a radiator, and an enclosure frame, wherein:
the resonator is disposed on a side of the reflector and is configured to filter a signal of the antenna;
the radiator is disposed on a side of the resonator facing away from the reflector, and the radiator and the resonator are electrically connected; and
the enclosure frame is disposed on the same side on the reflector as the resonator, and forms, with the reflector, an accommodating space for accommodating the resonator and the radiator, and the enclosure frame has a metal surface.

2. The antenna according to claim 1, further comprising a metal sheet, wherein the metal sheet is fastened on a side of the enclosure frame facing away from the reflector.

3. The antenna according to claim 1, further comprising a first baffle plate and a second baffle plate, wherein the first baffle plate and the second baffle plate are oppositely disposed on the same side on the reflector as the resonator, the first baffle plate and the second baffle plate are separately located outside the enclosure frame, and both the first baffle plate and the second baffle plate have a metal surface.

4. The antenna according to claim 1, further comprising a phase adjustment structure, wherein the phase adjustment structure is disposed on the side of the enclosure frame facing away from the reflector, and the phase adjustment structure is configured to adjust a phase of the signal of the antenna.

5. The antenna according to claim 4, wherein the phase adjustment structure comprises a dielectric substrate and a metal pattern disposed on a surface of the dielectric substrate.

6. The antenna according to claim 5, wherein there are one or more phase adjustment structures, and the one or more phase adjustment structures are sequentially disposed in a direction away from the reflector.

7. The antenna according to claim 4, wherein the phase adjustment structure is made of an all-dielectric material, and the phase adjustment structure comprises a plurality of regions having different thicknesses in a direction perpendicular to the reflector.

8. The antenna according to claim 7, wherein a thickness of the phase adjustment structure in the direction perpendicular to the reflector gradually decreases in a direction from a center of the phase adjustment structure to an edge of the phase adjustment structure.

9. The antenna according to claim 1, wherein the radiator is a dielectric resonator.

10. The antenna according to claim 9, wherein a surface on a side of the radiator facing away from the resonator has a metal plating layer.

11. The antenna according to claim 1, wherein the radiator is a microstrip resonator.

12. The antenna according to claim 1, wherein:
the resonator is a dielectric resonator, and the resonator comprises one or more resonance cavities; or
the resonator is a metal cavity resonator, and the resonator comprises a metal housing and a metal resonance rod disposed in the metal housing.

13. A communication device, comprising a baseband processing unit and an antenna electrically connected to the baseband processing unit, wherein:
the antenna comprises a reflector, a resonator, a radiator, and an enclosure frame;
the resonator is disposed on a side of the reflector and is configured to filter a signal of the antenna;
the radiator is disposed on a side of the resonator facing away from the reflector, and the radiator and the resonator are electrically connected; and
the enclosure frame is disposed on the same side on the reflector as the resonator, and forms, with the reflector, an accommodating space for accommodating the resonator and the radiator, and the enclosure frame has a metal surface.

14. The communication device according to claim 13, further comprising a metal sheet, wherein the metal sheet is fastened on a side of the enclosure frame facing away from the reflector.

15. The communication device according to claim 13, further comprising a first baffle plate and a second baffle plate, wherein the first baffle plate and the second baffle plate are oppositely disposed on the same side on the reflector as the resonator, the first baffle plate and the second baffle plate are separately located outside the enclosure frame, and both the first baffle plate and the second baffle plate have a metal surface.

16. The communication device according to claim 13, further comprising a phase adjustment structure, wherein the phase adjustment structure is disposed on the side of the enclosure frame facing away from the reflector, and the phase adjustment structure is configured to adjust a phase of the signal of the antenna.

17. The communication device according to claim 16, wherein the phase adjustment structure comprises a dielectric substrate and a metal pattern disposed on a surface of the dielectric substrate.

18. The communication device according to claim 17, wherein there are one or more phase adjustment structures, and the one or more phase adjustment structures are sequentially disposed in a direction away from the reflector.

19. The communication device according to claim 16, wherein the phase adjustment structure is made of an all-dielectric material, and the phase adjustment structure comprises a plurality of regions having different thicknesses in a direction perpendicular to the reflector.

20. (canceled)

21. An antenna, comprising a reflector, a resonator, a radiator, and a phase adjustment structure, wherein:
the resonator is disposed on a side of the reflector and is configured to filter a signal of the antenna;
the radiator is disposed on a side of the resonator facing away from the reflector, and the radiator and the resonator are electrically connected; and
the phase adjustment structure is disposed on a side of the radiator facing away from the reflector, and the phase adjustment structure is configured to adjust a phase of the signal of the antenna.
